(19) United States
(12) Patent Application Publication
(10) Pub. No.: US 2007/0166137 A1
(43) Pub. Date: Jul. 19, 2007

(54) Rolling device for a defective wheel pertaining to a motor vehicle

(75) Inventor: Terence Toal, Buttelborn (DE)

Correspondence Address: GUDRUN E. HUCKETT DRAUDT, LONSSTR. 59, WUPPERTAL, 42289, DE

(73) Assignee: Petra Hovermann, Emmendingen (DE)

(21) Appl. No.: 10/597,855

(22) PCT Filed: Jan. 28, 2005
(86) PCT No.: PCT/DE05/00133

§ 371 Date: Nov. 24, 2006

(30) Foreign Application Priority Data
Feb. 10, 2004 (DE) 102004006392.3

(51) Int. Cl. B60B 29/00

(52) U.S. Cl. 414/430

(57) ABSTRACT

A rolling device for a defective wheel of a motor vehicle has a carriage provided with rollers. The carriage receives a defective wheel to be driven onto the carriage. A belt for securing the defective wheel resting on the carriage is provided wherein the belt has a first end connected to a first end of the carriage. For driving the defective wheel onto the carriage, the belt is placed such in a first direction relative to the carriage onto the ground that the defective wheel when being driven onto the carriage rolls on the belt along the extension of the belt. When the defective wheel rests on the carriage, the belt is placed in a second direction, opposite to the first direction, across the defective wheel and is connected with its second end to the second end of the carriage for securing the defective wheel on the carriage.

The invention relates to a rolling device for a defective wheel of a motor vehicle according to the preamble of claim 1.

In the case of a defective wheel of a motor vehicle, in particular, in the case of a flat tire, it is necessary to replace the defective wheel with a spare wheel. This is technically complex because first the motor vehicle must be lifted by means of a car jack; this requires some technical expertise. Moreover, a certain amount of force is required in order to loosen the screws and to tighten them again, on the one hand, and in order to remove the defective wheel from the wheel hub and to put the spare wheel onto the wheel hub, on the other hand. Often it is then also difficult to center the wheel rim precisely relative to the screw holes. Moreover, one becomes easily soiled when performing these tasks. In the end, it is necessary to always have a spare wheel on board, and this requires extra space. In particular in the case of small motor vehicles, this space requirement is a disadvantage.

For this reason, German published application 21 34 583 proposes a so-called rolling device for a defective wheel of a motor vehicle of the aforementioned kind. The basic idea of the rolling device is a carriage provided with rollers. On this carriage, the defective wheel is positioned and secured. In this state, the motor vehicle can be driven to the next repair shop.

The known rolling device, on the one hand, has the disadvantage that the carriage can easily roll away when driving the wheel onto it so that a special securing device must be provided. On the other hand, the fixation device for securing the wheel on the carriage is not optimal with regard to handling and functional safety.

Based on this, it is an object of the invention to provide a rolling device for a defective wheel of a motor vehicle of the aforementioned kind with a simplified possibility for the carriage not to roll away when driving the wheel onto the carriage. Moreover, an improved fixation device for the wheel on the carriage should be provided.

The technical solution is characterized by the features of the characterizing portion of claim 1.

The basic idea of the rolling device according to the invention for a defective wheel of a motor vehicle resides in that a belt having a dual function is provided. Its first function prevents that the carriage when driving the wheel onto the carriage does not roll away because the wheel rests on the belt that is placed on the ground; in this way, the carriage is secured by means of this belt. The second function resides in that after having driven the wheel onto the carriage the belt is then used to secure the wheel on the carriage in that essentially the wheel is secured on the carriage by tightening the belt. In this way, a safe securing action of the wheel on the carriage is ensured without their being the risk that the wheel rolls off the carriage when driving the vehicle. As a whole, in this way a rolling device for a defective wheel of a motor vehicle is provided that has improved functionality.

While one end of the belt is fixedly and permanently secured on the carriage, the embodiment of claim 2 proposes that the belt can be hooked by means of its free end onto the carriage. In this way, it is possible to quickly and simply tighten the belt for securing the wheel on the carriage.

In order to be able to transport by means of the rolling device wheels of different diameters, the embodiment according to claim 3 proposes that the belt is adjustable with regard to its length. This can be realized, for example, by a length-adjustable loop.

The embodiment according to claim 4 has the advantage that because of the ramp the wheel can be driven without problems onto the carriage. In this connection, the belt can extend underneath the ramp or, preferably, on the slanted topside of the ramp. In any case, in both positions the belt is fixed while the wheel is driven onto the carriage.

The embodiment according to claim 5 proposes that the ramp is configured separate from the carriage. This has the advantage that the ramp in the driving position, i.e., in the position of use of the rolling device, is not disruptive because it can be removed. Preferably, in the position of non-use of the rolling device, the ramp can be placed into the wheel depression of the carriage.

Preferably, according to claim 6, the ramp can be hooked from above onto the carriage. In this way, a safe connection between the carriage and the ramp is provided without these two parts being able to become detached when driving the wheel onto the carriage. Since the ramp can be hooked from above onto the carriage, mounting and demounting are simple.

Preferably, according to claim 7, the ramp can be hooked onto an axle of the carriage.

A constructive embodiment of the carriage according to claim 8 proposes that the carriage is comprised of two basic components, i.e., a bottom part as well as a top part. The bottom part is comprised preferably of sheet metal and serves for supporting the rollers and provides as a whole the required stability to the rolling device. The top part is then placed onto this bottom part and the top part is preferably an injection-molded plastic part. In this way, as a whole a rolling device is provided that is very stable and is comprised of only a few components.

Finally, the embodiment according to claim 9 proposes that the carriage has three rollers. In this connection, a roller pair can be fixedly connected to an axle while the third roller is rotatable about a vertical axle.

One embodiment of the rolling device according to the invention for a defective wheel of a motor vehicle will be described in the following with the aid of the drawings. The drawings show:

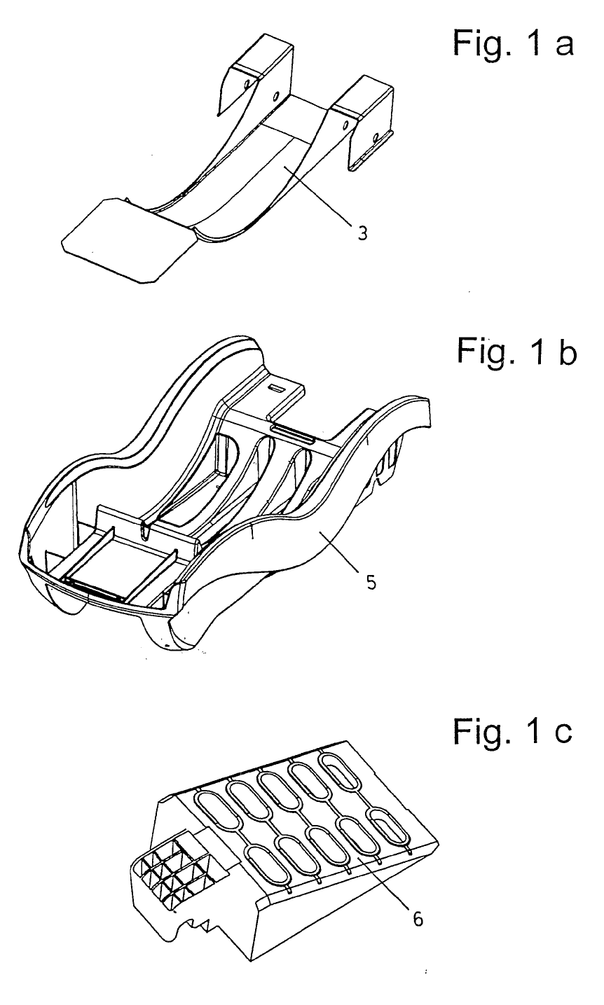

FIG. 1a the bottom part of the rolling device as a sheet metal insert in a perspective illustration;

FIG. 1b the top part of the rolling device in the form of a plastic member in a perspective illustration;

FIG. 1c the ramp of the rolling device in a perspective illustration;

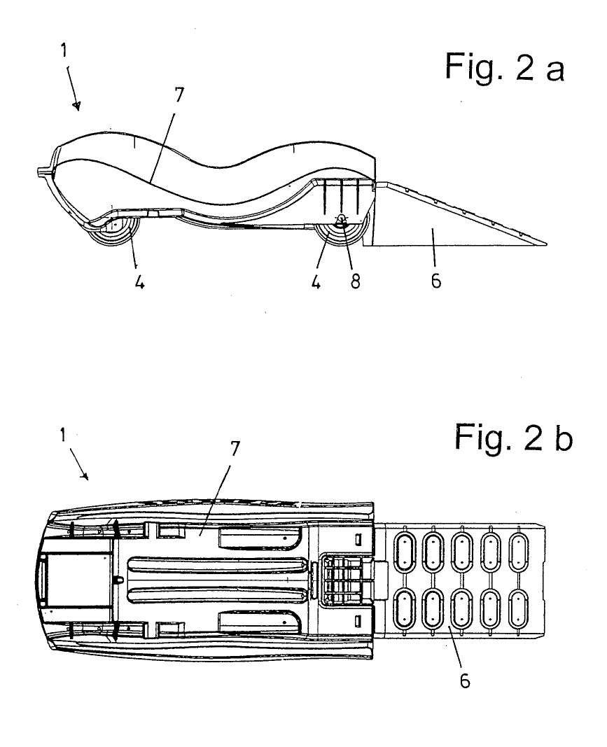

FIG. 2a the assembled rolling device in a side view;

FIG. 2b the rolling device of FIG. 2a in a plan view;

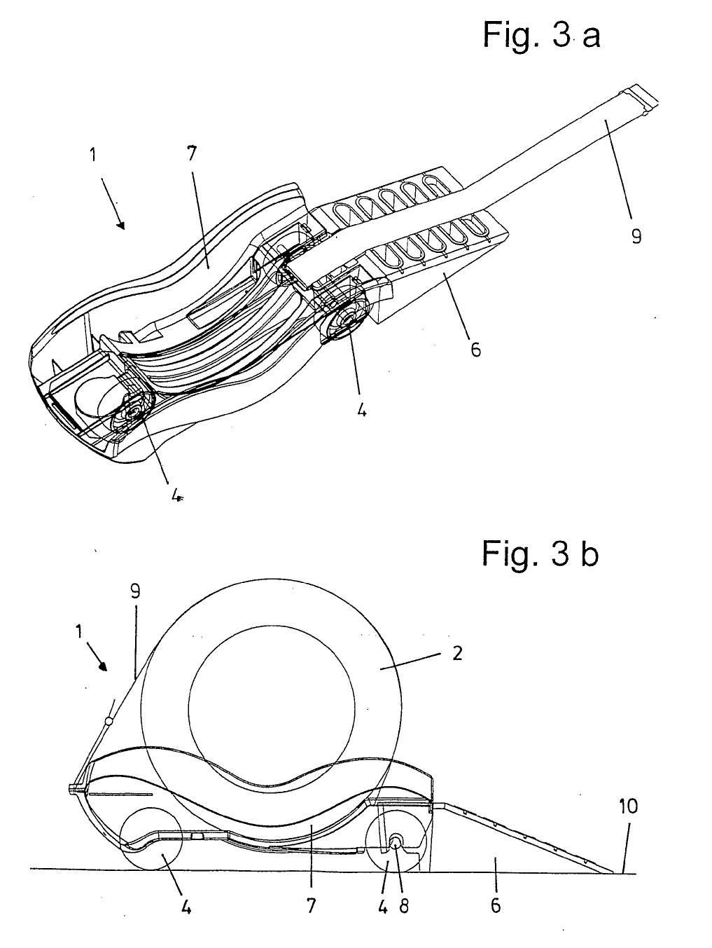

FIG. 3a a perspective view of the rolling device with extended belt;

FIG. 3b the rolling device of FIG. 3a in a side view with the wheel positioned on the rolling device and the belt in secured position.

The rolling device 1 for a defective wheel 2 of a motor vehicle is comprised of three basic elements.

First, a bottom part 3 in the form of a sheet metal insert is provided (FIG. 1a). This bottom part 3 serves for supporting three rollers 4. In FIG. 1a it is shown that at the rear of the bottom part 3 four recesses are provided through which an axle 8 can be pushed which supports externally a roller pair 4. An additional roller 4 is provided in the front area of FIG. 1a. This roller is freely rotatable about a horizontal axis and a vertical axis.

The second basic element of the rolling device 1 is a top part 5 of plastic material (FIG. 1b). It has a tub shape and has lateral web-like elements. This top part 5 is placed onto the bottom part 3.

As a third basic element the ramp 6 is provided. It is a solid member of plastic material provided with holes. The holes increase additionally grip when driving the wheel onto the carriage.

The carriage 7 is comprised of the bottom part 3 having rollers 4 and the top part 5 placed thereon. In this connection, the ramp 6 is placed from above by means of projecting extensions onto the axle 8 of the roller pair 4. FIG. 3a also shows that on the carriage 7, i.e., on the top part 5, a flat belt 9 is fastened.

The function is as follows.

In the initial state, the ramp 6 is hooked from above onto the carriage 7 and forms a fixed connection. The belt 9 is placed like a tail across the ramp 6 onto the ground 10.

The vehicle having a defective wheel 2 rolls from the rear across the belt 9 in the direction toward the carriage 7. Since the carriage 7 is attached to the belt 9 and since the belt 9 is fixed by the wheel 2 to the ground 10, the carriage (as well as the ramp 6) cannot roll away. The wheel 2 rolls thus on the belt 9 up the ramp 6 and drops into the depression of the carriage 7.

For securing the wheel 2 on the carriage 7, the belt 9 is now placed about the wheel 2 and attached to the other side of the carriage 7. The wheel 2 is thus secured on the carriage 7 by the tightened belt 9.

Finally, the ramp 6 is removed.

In this state, the motor vehicle can continue to drive to the next repair shop despite having a defective wheel 2.

In the position of non-use of the rolling device, the ramp 6 is placed into the top wheel depression of the carriage 7 in order to save space.

### LIST OF REFERENCE NUMERALS

1 rolling device
2 wheel
3 bottom part
4 roller
5 top part
6 ramp
7 carriage
8 axle
9 belt
10 ground

What is claimed is:

1.-9. (canceled)

10. A rolling device for a defective wheel of a motor vehicle, the rolling device comprising:
a carriage provided with rollers and adapted to receive a defective wheel to be driven onto the carriage;
a belt for securing the defective wheel when resting on the carriage, wherein the belt has a first end connected to a first end of the carriage;
wherein, for driving the defective wheel onto the carriage, the belt is placed such in a first direction relative to the carriage onto the ground that the defective wheel when being driven onto the carriage rolls on the belt along the extension of the belt; and
wherein, when the defective wheel rests on the carriage, the belt is placed in a second direction, opposite to the first direction, across the defective wheel and is connected with a second end to a second end of the carriage.

11. The rolling device according to claim 10, wherein the second end of the belt is adapted to be hooked onto the second end of the carriage.

12. The rolling device according to claim 10, wherein the belt has a length that is adjustable.

13. The rolling device according to claim 10 further comprising a ramp for driving the defective wheel onto the carriage, wherein the belt extends underneath or on top of the ramp when placed onto the ground.

14. The rolling device according to claim 13, wherein the ramp and the carriage are separate parts.

15. The rolling device according to claim 14, wherein the ramp is adapted to be hooked onto the carriage.

16. The rolling device according to claim 15, wherein the carriage has an axle and the ramp is hooked onto the axle.

17. The rolling device according to claim 10, wherein the carriage is comprised of a bottom part provided with the rollers and further comprised of a top part that is arranged on top of the bottom part.

18. The rolling device according to claim 17, wherein the bottom part is made of sheet metal and wherein the top part is made of plastic material.

19. The rolling device according to claim 10, wherein the carriage has three of said rollers.
